(19) United States
(12) Patent Application Publication
(10) Pub. No.: US 2006/0142499 A1
(43) Pub. Date: Jun. 29, 2006

(54) Process for preparation of polyvinyl alcohol-polyether graft copolymers via extrusion

(75) Inventors: Norbert Guntherberg, Speyer (DE); Tanja Seebeck, Bensheim (DE); Ronald Frans Maria Lange, Ludwigshafen (DE)

Correspondence Address: CONNOLLY BOVE LODGE & HUTZ, LLP, P O BOX 2207, WILMINGTON, DE, 19899, US

(73) Assignee: BASF Aktiengesellschaft, Ludwigshafen (DE)

(21) Appl. No.: 11/304,773

(22) Filed: Dec. 16, 2005

(30) Foreign Application Priority Data
Dec. 23, 2004 (DE) 102004062200.0

(51) Int. Cl. C08F 297/02

(52) U.S. Cl. 525/242

(57) ABSTRACT

The present invention relates to a process for preparation of graft copolymers which have repeat units derived from vinyl alcohol and have polyether groups, via reactive extrusion of corresponding graft copolymers based on esters of vinyl alcohol in the presence of water and/or of at least one C₁-C₆ alkanol, and of a base.

The present invention relates to a process for preparation of graft copolymers which have repeat units derived from vinyl alcohol and have polyether groups, via reactive extrusion of corresponding graft copolymers based on esters of vinyl alcohol in the presence of water and/or of at least one C₁-C₆ alkanol, and of a base. The invention further relates to the use of the graft copolymers obtainable by this process.

Polyvinyl alcohols are very versatile, e.g. in the form of protective colloids, emulsifiers, metal-protection coatings, thickeners, and for production of ointments, of emulsions, and of water-soluble packaging foils. For specific applications or processing methods, the properties of polyvinyl alcohols are advantageously adjusted via combination with other polymers, in particular in the form of block copolymers comprising copolymerized vinyl alcohol, and especially graft copolymers. By way of example, WO 03/070224 describes film coatings for solid substrates which comprise at least one polyvinyl alcohol-polyether graft copolymer in combination with at least one component having hydroxy, amide, or ester functions.

Because the concentration of monomeric vinyl alcohol in the tautomeric equilibrium with acetaldehyde is too low, polyvinyl alcohols cannot be directly prepared via polymerization of the monomer. Polyvinyl alcohols are therefore predominantly prepared from polyvinyl esters, especially polyvinyl acetates, by way of polymer-analogous reactions, such as hydrolysis, and via alkaline-catalyzed transesterification with alcohols. The resultant degree of hydrolysis and therefore the residue content of acetyl groups has a decisive effect on the properties of the product, in particular solubility behavior. Familiar methods for influencing water-solubility consist in post-treatment with aldehydes, complexing with Ni salts or with Cu salts, or treatment with dichromates, boric acid, or borax.

The properties of block copolymers having polyvinyl alcohol units and units which derive from other polymers, such as polyethers, actually depend on the nature of the polymer blocks and on the manner of their linkage. In particular, both the quantitative proportion of the polymer blocks with respect to one another and the degree of hydrolysis of the polyvinyl alcohol blocks present may be varied. In this connection, mention may be made, by way of example, of polyalkylene glycol-polyvinyl alcohol graft copolymers, which can be adjusted to give very good water-solubility, depending on the degree of hydrolysis achieved. Polymers of this type are therefore suitable candidates for water-soluble coatings or packaging materials, which are generally produced via thermoplastic processes.

Among the requirements to be placed upon coatings and packaging materials of this type, in particular foils, are not only the water-solubility desired but also the degree of tack of the polymer product, and, in the case of foils, their sealability. Both properties are affected by the degree of hydrolysis of the polyvinyl alcohol blocks in the block copolymers. A general rule here is that as the degree of hydrolysis increases the water-solubility of the polymer increases and tack decreases. Ideal sealability includes the ability to obtain a good weld seam without brittleness or tack of the foil.

The reaction of polyvinyl acetates with alkanols in a basic alcohol solution is described by way of example in Ullmann's Encyclopedia of Industrial Chemistry, 5th edition on CD-ROM, polyvinyl compounds, others—poly(vinyl alcohol), 1.2. production. In association with the conventional work-up via steam distillation, spray drying, and granulation, this conventional process is very complicated. For example, in order to remove organic solvents and the by-products present during the hydrolysis process, the polymer generally has to be first dissolved by adding water, or the polymer gel obtained during the reaction has to be diluted. (A sharp increase in viscosity during the reaction and gel formation occur because it is generally only the starting materials that are soluble in the solvent used, e.g. methanol, and not the products). The undesired components are then removed via steam distillation. In order to convert the resultant polymers into a form capable of thermoplastic processing, the polymer solution has to be dried, e.g. via spray drying. This procedure is economically disadvantageous. There is therefore a need to minimize the complicated steps required in the process for preparation of graft copolymers comprising vinyl alcohol in copolymerized form.

DE-B 1 081 229 and DE-B 1 094 457 describe the alkaline and acidic hydrolysis and, respectively, transesterification of graft polymers of vinyl esters onto polyalkylene glycols. By way of example, a methanolic solution of sodium hydroxide or of potassium hydroxide is used for the alkaline alcoholysis process.

WO 00/18375 describes the use of polymers obtainable via polymerization of at least one vinyl ester in the presence of at least one polyether, and of their saponification products as coating compositions, binders, and/or of film-forming auxiliary in pharmaceutical dosage forms. Although extrusion and calendering of the finished polymers to produce medicaments is described, there is no disclosure of reactive extrusion to carry out the hydrolysis reaction.

WO 95/02616 describes a process for transesterification of a polymer having a polyethylene backbone and ester groups in the side chains, via reactive extrusion. No alcoholysis takes place under the reactive conditions described.

U.S. Pat. No. 3,072,624 describes a process for preparation of polyvinyl alcohol via hydrolysis of polyvinyl acetate, where the still flowable reaction mixture is made to flow vertically through a mixer, and then is transferred into a twin-screw extruder for further hydrolysis.

EP-A-0054716 describes a continuous process for partial alcoholysis of polyvinyl acetate homo- or copolymers, which premixes a methanolic solution of the polymer and a methanolic solution of a basic catalyst in a mixing zone, and introduces the resultant mixture into a reaction zone, where the mixing zone and the reaction zone are formed from a combination of a static mixer with a twin-rotor mixer or mixing extruder. Comonomers mentioned comprise (meth)acrylic acid, methyl (meth)acrylate, mono- and diesters of maleic acid, dimethylaminoethyl vinyl ether, and α-olefins having from 2 to 18 carbon atoms. Nothing is said concerning the structure of the copolymers used, and no mention is made of graft copolymers.

It is an object of the present invention to provide a process which is simple to carry out for production of graft copolymers comprising vinyl alcohol in copolymerized form, and which can be carried out without complicated steps, in particular without steam distillation or spray drying. The process should give the product in a form which permits advantageous use in injection-molding or foil-extrusion processes. A particular feature of the inventive process should be that the degree of hydrolysis of the resultant polymer product can be adjusted reliably.

The invention achieves the object via a process for preparation of graft copolymers P2) which have repeat units derived from vinyl alcohol and have polyether groups, via reaction of graft copolymers P1) which have repeat units derived from esters of vinyl alcohol and have polyether groups, with water and/or with at least one C₁-C₆ alkanol in the presence of a catalyst, where the reaction takes place in an extruder.

The inventive process permits, in particularly advantageous fashion, the steps previously carried out in separate apparatus to be carried out in a single apparatus, the extruder, these steps being alcoholysis, steam distillation, and spray drying. Furthermore, the resultant extrudate can easily be granulated, and the resultant granules have good suitability for further processing via injection molding, or for production of foils. By way of example, it has been found that the polymer powders obtained by known processes and composed of graft copolymers having vinyl alcohol repeat units and having polyether groups have only poor suitability as starting material for injection-molding processes or film-extrusion processes, because these powders give only inadequate and non-uniform feed to the tooling. These disadvantages can be overcome by using granulated products obtained by the inventive process.

The inventive process moreover permits the use of solutions of the graft copolymer P1) with markedly higher solids content than do the processes known from the prior art, because the increase in viscosity during the reaction and the gel formation sometimes associated therewith have less effect under the conditions of shear and conveying in an extruder.

For the purposes of the present invention, the term alkyl comprises straight-chain and branched alkyl groups. Examples of suitable short-chain alkyl groups are straight-chain or branched C₁-C₇-alkyl groups, preferably C₁-C₆-alkyl groups and particularly preferably C₁-C₄-alkyl groups. Among these are in particular methyl, ethyl, propyl, isopropyl, n-butyl, 2-butyl, sec-butyl, tert-butyl, n-pentyl, 2-pentyl, 2-methylbutyl, 3-methylbutyl, 1,2-dimethylpropyl, 1,1-dimethylpropyl, 2,2-dimethylpropyl, 1-ethylpropyl, n-hexyl, 2-hexyl, 2-methylpentyl, 3-methylpentyl, 4-methylpentyl, 1,2-dimethylbutyl, 1,3-dimethylbutyl, 2,3-dimethylbutyl, 1,1-dimethylbutyl, 2,2-dimethylbutyl, 3,3-dimethylbutyl, 1,1,2-trimethylpropyl, 1,2,2-trimethylpropyl, 1-ethylbutyl, 2-ethylbutyl, 1-ethyl-2-methylpropyl, n-heptyl, 2-heptyl, 3-heptyl, 2-ethylpentyl, 1-propylbutyl, octyl, etc.

Suitable longer-chain C₈-C₃₀-alkyl groups or C₈-C₃₀-alkenyl groups are straight-chain and branched alkyl or alkenyl groups. These are preferably predominantly linear alkyl radicals such as those also found in naturally occurring or synthetic fatty acids and fatty alcohols, and also in oxo alcohols, and these may, if appropriate, also have mono-, di- or polyunsaturation. Examples of these are n-hexyl(ene), n-heptyl(ene), n-octyl(ene), n-nonyl(ene), n-decyl(ene), n-undecyl(ene), n-dodecyl(ene), n-tridecyl(ene), n-tetradecyl(ene), n-pentadecyl(ene), n-hexadecyl(ene), n-heptadecyl(ene), n-octadecyl(ene), n-nonadecyl(ene), etc.

Cycloalkyl is preferably C₅-C₈-cycloalkyl, such as cyclopentyl, cyclohexyl, cycloheptyl, or cyclooctyl.

For the purposes of the present invention, the term heterocycloalkyl comprises saturated, cycloaliphatic groups generally having from 4 to 7, preferably 5 or 6, ring atoms, in which 1 or 2 of the ring carbon atoms have been replaced by heteroatoms, selected from the elements oxygen, nitrogen, and sulfur, and which may, if appropriate, have substitution, and if substitution is present these heterocycloaliphatic groups have 1, 2, or 3, preferably 1 or 2, particularly preferably 1, substituent(s) selected from alkyl, aryl, COOR^{a}, COO⁻M⁺, and NE¹E², preferably alkyl. By way of example of these heterocycloaliphatic groups, mention may be made of pyrrolidinyl, piperidinyl, 2,2,6,6-tetramethylpiperidinyl, imidazolidinyl, pyrazolidinyl, oxazolidinyl, morpholidinyl, thiazolidinyl, isothiazolidinyl, isoxazolidinyl, piperazinyl, tetrahydrothiophenyl, tetrahydrofuranyl, tetrahydropyranyl, dioxanyl.

Aryl comprises unsubstituted and substituted aryl groups, and is preferably phenyl, tolyl, xylyl, mesityl, naphthyl, fluorenyl, anthracenyl, phenanthrenyl, naphthacenyl, and in particular phenyl, tolyl, xylyl, or mesityl.

Substituted aryl radicals preferably have 1, 2, 3, 4, or 5, in particular 1, 2, or 3, substituents selected from alkyl, alkoxy, carboxy, carboxylate, trifluoromethyl, —SO₃H, sulfonate, NE¹E², alkylene-NE¹E², nitro, cyano, or halogen.

Hetaryl is preferably pyrrolyl, pyrazolyl, imidazolyl, indolyl, carbazolyl, pyridyl, quinolinyl, acridinyl, pyridazinyl, pyrimidinyl, or pyrazinyl.

Compounds which derive from acrylic acid and methacrylic acid may sometimes be abbreviated hereinafter by introducing the syllable “(meth)” into the compound derived from acrylic acid.

The terms “hydrolysis” and “alcoholysis” are used synonymously hereinafter, and the person skilled in the art is aware that when water is used for the reaction the free acid is obtained and when alcohols are used the corresponding transesterification products are obtained.

The graft copolymers P1) used according to the invention preferably have a backbone comprising polyether groups and have side chains having vinyl ester repeat units.

In the polymers P1), the quantitative ratio by weight of the polyether groups with respect to the repeat units derived from esters of vinyl alcohol and, if appropriate, from other monomers is in the range from 1:0.5 to 1:50, preferably from 1:1 to 1:35, in particular from 1:1.5 to 1:30.

Graft copolymers P1) which are suitable for use in the inventive process and which have vinyl ester repeat units and have polyether groups, and processes for their preparation, are in principle known. Among these are poly(vinyl ester)-polyether graft copolymers obtainable, by way of example, via free-radical polymerization of at least one vinyl ester in the presence of at least one polyether. The term “graft copolymers” here comprises very generally all of the products obtainable via free-radical copolymerization of at least one vinyl ester and, if appropriate, of other monomers, in the presence of at least one polyether component. This term comprises not only pure graft polymers but also the products of only partial grafting onto the polyether component, among which are, for example, mixtures of graft polymers with ungrafted polyether compounds, homo- and copolymers of the monomers used, and also any desired mixture.

DE-B-1 007 430, WO 00/18375, and WO 03/070224, the entire scope of which is incorporated herein by way of reference, describe graft copolymers P1) which are suitable for the inventive process and which have vinyl ester repeat units and have polyether groups, and describe processes for their preparation.

The preferred suitable compounds for preparing the poly(vinyl ester)-polyether graft copolymers are vinyl esters of linear and branched C₁-C₃₀ carboxylic acids, particularly preferably C₁-C₁₂ carboxylic acids, and their derivatives. Suitable vinyl esters are vinyl formate, vinyl acetate, vinyl propionate, vinyl butyrate, vinyl chloroacetate, vinyl dichloroacetate, vinyl bromoacetate, vinyl trifluoroacetate, vinyl benzoate, and mixtures of these. The vinyl ester component particularly preferably comprises vinyl acetate or is composed thereof.

Other comonomers may be used to prepare the poly(vinyl ester)-polyether graft copolymers. The proportion of comonomers is preferably from 0 to 50% by weight, particularly preferably from 0.01 to 30% by weight, in particular from 1 to 10% by weight, based on the total weight of monomers used for the polymerization process.

Suitable comonomers are N-vinyllactams and N-vinyllactam derivatives, N-vinylamides of saturated monocarboxylic acids, primary amides of α,β-ethylenically unsaturated monocarboxylic acids, and their N-alkyl and N,N-dialkyl derivatives, esters of α,β-ethylenically unsaturated mono- and dicarboxylic acids with diols, amides of α,β-ethylenically unsaturated mono- and dicarboxylic acids with diamines which have at least one primary or secondary amino group, esters and amides of α,β-ethylenically unsaturated mono- and dicarboxylic acids with amino alcohols, esters of α,β-ethylenically unsaturated mono- and dicarboxylic acids with alkanols, esters of allyl alcohol with monocarboxylic acids, vinylaromatic compounds, vinyl halides, vinylidene halides, monoolefins, non-aromatic hydrocarbons having at least two conjugated double bonds, vinyl- and allyl-substituted nitrogen heterocycles, N,N-diallylamines, and N,N-diallyl-N-alkylamines, and their acid-adduct salts and quaternization products. Other suitable comonomers are any desired mixtures of the abovementioned monomers.

Suitable comonomers are N-vinyllactams and N-vinyllactam derivatives which, by way of example, may have one or more C₁-C₆ alkyl substituents, such as methyl, ethyl, n-propyl, isopropyl, n-butyl, sec-butyl, tert-butyl, etc. Among these are, for example, N-vinylpyrrolidone, N-vinylpiperidone, N-vinylcaprolactam, N-vinyl-5-methyl-2-pyrrolidone, N-vinyl-5-ethyl-2-pyrrolidone, N-vinyl-6-methyl-2-piperidone, N-vinyl-6-ethyl-2-piperidone, N-vinyl-7-methyl-2-caprolactam, N-vinyl-7-ethyl-2-caprolactam, etc. It is preferable to use N-vinylpyrrolidone, and N-vinylcaprolactam.

Other suitable comonomers are N-vinylformamide, N-vinyl-N-methylformamide, N-vinylacetamide, N-vinyl-N-methylacetamide, N-vinyl-N-ethylacetamide, N-vinylpropionamide, N-vinyl-N-methylpropionamide, N-vinylbutyramide, acrylamide, methacrylamide, N-methyl(meth)acrylamide, N-ethyl(meth)acrylamide, N-propyl(meth)acrylamide, N-(n-butyl)(meth)acrylamide, N-(tert-butyl)(meth)acrylamide, N,N-dimethyl(meth)acrylamide, N,N-diethyl(meth)acrylamide, piperidinyl(meth)acrylamide, morpholinyl(meth)acrylamide, N-[2-(dimethylamino)ethyl]acrylamide, N-[2-(dimethylamino)ethyl]methacrylamide, N-[3-(dimethylamino)propyl]acrylamide, N-[3-(dimethylamino)propyl]methacrylamide, N-[4-(dimethylamino)butyl]acrylamide, N-[4-(dimethylamino)butyl]methacrylamide, N-[2-(diethylamino)ethyl]acrylamide, N-[4-(dimethylamino)cyclohexyl]acrylamide, N-[4-(dimethylamino)cyclohexyl]methacrylamide, N-(n-octyl)(meth)acrylamide, N-(1,1,3,3-tetramethylbutyl)(meth)acrylamide, N-ethylhexyl(meth)acrylamide, N-(n-nonyl)(meth)acrylamide, N-(n-decyl)(meth)acrylamide, N-(n-undecyl)(meth)acrylamide, N-tridecyl(meth)acrylamide, N-myristyl(meth)acrylamide, N-pentadecyl(meth)acrylamide, N-palmityl(meth)acrylamide, N-heptadecyl(meth)acrylamide, N-nonadecyl(meth)acrylamide, N-arraquinyl(meth)acrylamide, N-behenyl(meth)acrylamide, N-lignocerenyl(meth)acrylamide, N-cerotinyl(meth)acrylamide, N-melissinyl(meth)acrylamide, N-palmitoleinyl(meth)acrylamide, N-oleyl(meth)acrylamide, N-linolyl(meth)acrylamide, N-linolenyl(meth)acrylamide, N-stearyl(meth)acrylamide, and N-lauryl(meth)acrylamide.

Other suitable comonomers are esters of α,β-ethylenically unsaturated mono- and dicarboxylic acids with diols. Examples of suitable acid components of these esters are acrylic acid, methacrylic acid, fumaric acid, maleic acid, itaconic acid, crotonic acid, maleic anhydride, monobutyl maleate, and mixtures of these. Preferred acid components are acrylic acid, methacrylic acid and mixtures of these. Suitable compounds are 2-hydroxyethyl acrylate, 2-hydroxyethyl methacrylate, 2-hydroxyethyl ethacrylate, 2-hydroxypropyl acrylate, 2-hydroxypropyl methacrylate, 3-hydroxypropyl acrylate, 3-hydroxypropyl methacrylate, 3-hydroxybutyl acrylate, 3-hydroxybutyl methacrylate, 4-hydroxybutyl acrylate, 4-hydroxybutyl methacrylate, 6-hydroxyhexyl acrylate, 6-hydroxyhexyl methacrylate, 3-hydroxy-2-ethylhexyl acrylate, and 3-hydroxy-2-ethylhexyl methacrylate.

Other suitable comonomers are esters of the abovementioned α,β-ethylenically unsaturated mono- and dicarboxylic acids with amino alcohols. Preferred amino alcohols are C₂-C₁₂ amino alcohols which may have been C₁-C₈-dialkylated on the amino nitrogen. Examples of suitable compounds are 2-hydroxyethylacrylamide, 2-hydroxyethylmethacrylamide, 2-hydroxyethylethacrylamide, 2-hydroxypropylacrylamide, 2-hydroxypropylmethacrylamide, 3-hydroxypropylacrylamide, 3-hydroxypropylmethacrylamide, 3-hydroxybutylacrylamide, 3-hydroxybutylmethacrylamide, 4-hydroxybutylacrylamide, 4-hydroxybutylmethacrylamide, 6-hydroxyhexylacrylamide, 6-hydroxyhexylmethacrylamide, 3-hydroxy-2-ethylhexylacrylamide, and 3-hydroxy-2-ethylhexylmethacrylamide.

Other suitable comonomers are amides of the abovementioned α,β-ethylenically unsaturated mono- and dicarboxylic acids with diamines which have at least one primary or secondary amino group. Preference is given to diamines which have one tertiary and one primary or secondary amino group. Examples of suitable compounds are N,N-dimethylaminomethyl (meth)acrylate, N,N-dimethylaminoethyl (meth)acrylate, N,N-diethylaminoethyl (meth)acrylate, N,N-dimethylaminopropyl (meth)acrylate, N,N-diethylaminopropyl (meth)acrylate, and N,N-dimethylaminocyclohexyl (meth)acrylate.

Other suitable comonomers are esters of the abovementioned α,β-ethylenically unsaturated mono- and dicarboxylic acids with alkanols, in particular with C₁-C₁₂ alkanols. Suitable other monomers are then methyl (meth)acrylate, methylethacrylate, ethyl (meth)acrylate, ethylethacrylate, n-butyl (meth)acrylate, tert-butyl (meth)acrylate, tert-butylethacrylate, n-octyl (meth)acrylate, 1,1,3,3-tetramethylbutyl (meth)acrylate, ethylhexyl (meth)acrylate, n-nonyl (meth)acrylate, n-decyl (meth)acrylate, n-undecyl (meth)acrylate, tridecyl (meth)acrylate, myristyl (meth)acrylate, pentadecyl (meth)acrylate, palmityl (meth)acrylate, heptadecyl (meth)acrylate, nonadecyl (meth)acrylate, arrachinyl (meth)acrylate, behenyl (meth)acrylate, lignocerenyl (meth)acrylate, cerotinyl (meth)acrylate, melissinyl (meth)acrylate, palmitoleinyl (meth)acrylate, oleyl (meth)acrylate, linolyl (meth)acrylate, linolenyl (meth)acrylate, stearyl (meth)acrylate, lauryl (meth)acrylate, and mixtures of these.

Other suitable comonomers are ethylene, propylene, isobutylene, butadiene, styrene, α-methylstyrene, acrylonitrile, methacrylonitrile, vinyl chloride, vinylidene chloride, vinyl fluoride, vinylidene fluoride, vinylimidazole, 2- and 4-vinylpyridine, 2- and 4-allyl-pyridine, N,N-diallyl-N-methylamine, and N,N-diallyl-N,N-dimethylammonium compounds, such as the chlorides and bromides. Among these are in particular N,N-diallyl-N,N-dimethylammonium chloride (DADMAC).

Alongside these vinyl esters, use is generally made only of those comonomers which are substantially inert under the conditions of the extrusion process. In particular, the units other than the polyvinyl ester units have no functional groups which, under the reaction conditions, react with aqueous or alcoholic solutions of bases.

The graft base used for the reaction with the abovementioned monomers generally comprises C—C-bonds having ethylenic unsaturation or having a higher degree of unsaturation. Polyether-containing compounds suitable as graft base are generally water-soluble or water-dispersible, non-ionic polymers which have polyalkylene glycol groups. The proportion of polyalkylene glycol groups is preferably at least 40% by weight, based on the total weight of the compound comprising polyether groups. Examples of polyether-containing compounds which may be used are polyalkylene glycols, polyesters based on polyalkylene glycols, and polyether urethanes.

Depending on the nature of the monomer units used for their preparation, the structural units present in the polyether-containing compounds are the following:
—(CH₂)₂—O—, —(CH₂)₃—O—, —(CH₂)₄—O—, —CH₂—CH(R¹)—O—, where
R¹ is C₁-C₂₄-alkyl, preferably C₁-C₄-alkyl.

The compounds comprising polyether groups may also have bridging groups, for example selected from:
—C(═O)—O—, —O—C(═O)—O—, —C(═O)—NR^{a}—, —O—C(═O)—NR^{a}—, —NR^{b}—(C═O)—NR^{a}—
where R^{a} and R^{b}, independently of one another, are hydrogen, C₁-C₃₀-alkyl, preferably C₁-C₄-alkyl, or cycloalkyl.

The polyethers used preferably comprise those of the general formula, with molecular weight >300 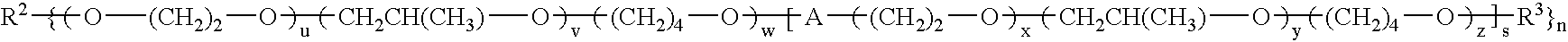
where the variables, independently of one another, are defined as follows:
R² is hydrogen, C₁-C₂₄-alkyl, R⁴—C(═O)—, R⁴—NH—C(═O)—, polyalcohol radical;
R³ is hydrogen, C₁-C₂₄-alkyl, R⁴—C(═O)—, R⁴—NH—C(═O)—;
R⁴ is C₁-C₂₄-alkyl;
A is —C(═O)—O, —C(═O)—B—C(═O)—O, —C(═O)—NH—B—NH—C(═O)—O;
B is —(CH₂)ₜ—, unsubstituted or substituted cycloalkylene, heterocycloalkylene, or arylene;
n is from 1 to 200, preferably from 1 to 100;
s is from 0 to 1000, preferably from 0 to 100;
t is from 2 to 12, preferably from 2 to 6;
u is from 1 to 1000, preferably from 1 to 500;
v is from 0 to 1000, preferably from 1 to 500;
w is from 0 to 1000, preferably from 1 to 500;
x is from 0 to 1000, preferably from 1 to 500;
y is from 0 to 1000, preferably from 1 to 500;
z is from 0 to 1000, preferably from 1 to 500.

The terminal primary hydroxy groups of the polyethers prepared on the basis of polyalkylene oxides, and also the secondary OH groups of polyglycerol, may here be either present in unprotected form or else be etherified or esterified using alcohols whose chain length is C₁-C₂₄ or, respectively, carboxylic acids whose chain length is C₁-C₂₄, or may be reacted with isocyanates to give urethanes. It is preferable to use polyether polyols.

Preferred representatives of the abovementioned alkyl radicals which may be mentioned are branched or unbranched C₁-C₁₂-, particularly preferably C₁-C₆-alkyl chains.

The number-average molecular weight of the polyethers is preferably from 300 to 100 000, particularly preferably in the range from 500 to 50 000, very particularly preferably in the range from 800 to 40 000.

The polyether component used for grafting preferably comprises at least one polyalkylene glycol. The number-average molecular weight of the polyalkylene glycols is preferably in the range from 300 to 50 000, particularly preferably in the range from 400 to 25 000, very particularly preferably in the range from 500 to 10 000. Preferred polyalkylene glycols are polyethylene glycols, polypropylene glycols, polytetrahydrofurans, and block copolymers composed of alkylene oxides, particularly preferably block copolymers composed of ethylene oxide, and propylene oxide, or block copolymers composed of ethylene oxide, propylene oxide, and butylene oxide. These block copolymers may comprise the copolymerized alkylene oxide units in random distribution or in the form of blocks. Suitable polytetrahydrofurans can be prepared via cationic polymerization of tetrahydrofuran in the presence of acidic catalyst, e.g. sulfuric acid or fluorosulfuric acid. These preparation processes are known to the person skilled in the art.

For grafting it is advantageous to use homo- and copolymers of ethylene oxide. The ethylene oxide content of the copolymers is preferably in the range from 40 to 99% by weight.

Alongside straight-chain polyalkylene glycols, branched polyalkylene glycols may also be used as graft base. Branched polyalkylene glycols may be prepared by an addition reaction of alkylene oxides onto polyalcohol residues, e.g. onto pentaerythritol, glycerol, or sugar alcohols, such as D-sorbitol and D-mannitol, or else onto polysaccharides, such as cellulose and starch.

Suitable commercially available polyalkylene glycols are alkyl polyethylene glycols, e.g. Pluriol® A 1000 PE, Pluriol® A 1000 E (methylpolyethylene glycol), alkylpolypropylene glycols, such as Pluriol® A 1350 P, polyethylene glycols, such as Pluriol® E 1000, Pluriol® E 6000 E, and Pluriol® E 8000 E (all from BASF Aktiengesellschaft), etc.

However, the polyester-containing compound used may also comprise polyesters derived from polyalkylene oxides and from aliphatic or aromatic dicarboxylic acids, e.g. oxalic acid, succinic acid, adipic acid, and terephthalic acid, with molecular weights of from 1500 to 25 000, e.g. as described in EP-A-0 743 962. It is also possible to use polycarbonates via reaction of polyalkylene oxides with phosgene or with carbonates, e.g. diphenyl carbonate, or else polyurethanes via reaction of polyalkylene oxides with aliphatic and aromatic diisocyanates.

In another suitable embodiment, the grafting process uses a polyether component which comprises at least one polyether urethane. Suitable polyether urethanes are the condensates of polyether polyols, such as polyetherdiols, with polyisocyanates, such as diisocyanates. Suitable polyether polyols are the abovementioned polyalkylene glycols, obtainable, by way of example, from the polymerization of cyclic ethers, such as tetrahydrofuran, or from the reaction of one or more alkylene oxides with a starter molecule which has two or more active hydrogen atoms. Suitable polyisocyanates are those selected among compounds having from 2 to 5 isocyanate groups, isocyanate prepolymers having an average number of from 2 to 5 isocyanate groups, and mixtures of these. Among these are, for example, aliphatic, cycloaliphatic, and aromatic di-, tri-, and polyisocyanates. Examples of suitable diisocyanates are tetramethylene diisocyanate, hexamethylene diisocyanate, 2,3,3-trimethylhexamethylene diisocyanate, cyclohexylene 1,4-diisocyanate, isophorone diisocyanate, phenylene 1,4-diisocyanate, toluylene 2,4- and 2,6-diisocyanate, and their isomer mixtures (e.g. 80% of 2,4- and 20% of 2,6-isomer), naphthylene 1,5-diisocyanate, diphenylmethane 2,4- and 4,4′-diisocyanate. An example of a suitable triisocyanate is triphenylmethane 4,4′,4″-triisocyanate. Other suitable compounds are isocyanate prepolymers and polyisocyanates, obtainable via addition reactions of the abovementioned isocyanates onto polyfunctional hydroxy- or amine-group-containing compounds. Other suitable compounds are polyisocyanates produced via a biuret- or isocyanurate-forming process. It is preferable to use hexamethylene diisocyanate, trimerized hexamethylene diisocyanate, isophorone diisocyanate, toluylene 2,4-diisocyanate, toluylene 2,6-diisocyanate, or a mixture of these.

Known processes can be used to prepare graft copolymers which can be used in the inventive process and which have repeat units derived from vinyl alcohol and have polyether groups. Among these processes are, by way of example, solution polymerization, precipitation polymerization, suspension polymerization, or emulsion polymerization, using compounds which form free radicals under the polymerization conditions. The polymerization temperatures are usually in the range from 10 to 200° C., preferably from 20 to 110° C. Examples of suitable initiators are azo compounds and peroxy compounds, and also the conventional redox initiator systems, such as combinations of hydrogen peroxide and compounds with reducing action, e.g. sodium sulfite, sodium bisulfite, sodium formaldehyde-sulfoxylate, and hydrazine. These systems may, if appropriate, also comprise very small amounts of a heavy metal salt.

The graft copolymers used according to the invention are reacted with water and/or with at least one C₁-C₆ alkanol, preferably with a C₁-C₄ alkanol. Preference is given to monohydric alcohols having a linear or branched saturated aliphatic carbon chain. Examples which may be mentioned are methanol, ethanol, n-propanol, isopropanol, 1-butanol, 2-butanol, isobutanol, tert-butanol, n-pentanol, 2-pentanol, 3-pentanol, 2,2-dimethylpropanol, 2-methyl-1-butanol, 2-methyl-2-butanol, 3-methyl-1-butanol, 3-methyl-2-butanol, 1-hexanol, 2-hexanol, 3-hexanol, 4-methyl-1-pentanol, 4-methyl-2-pentanol, 4-methyl-3-pentanol, 2-methyl-2-pentanol, 2-methyl-1-pentanol, 3-methyl-1-pentanol, 3-methyl-2-pentanol, 3-methyl-3-pentanol, 2-ethyl-1-butanol, 2,3-dimethyl-1-butanol, 2,3-dimethyl-2-butanol, 2-isopropyl-1-propanol, 2,2-dimethyl-1-butanol, 3,3-dimethyl-2-butanol, and 3,3-dimethyl-1-butanol. Particular preference is given to methanol, ethanol, n-propanol, and isopropanol, particularly methanol.

The reaction of the inventive process takes place using aqueous, aqueous/alcoholic, or alcoholic solution. The C₁-C₆ alkanols or water used for the reaction are advantageously also selected as solvent for the reaction. If the reaction uses a C₁-C₆ alkanol, such as methanol, it is advantageous in particular when using alkanolates of alkali metals or of alkaline earth metals as base, to restrict H₂O content to at most 1000 ppm, and preferably at most 500 ppm.

It has moreover proven advantageous to use an excess of the C₁-C₆ alkanol used for the reaction, e.g. of from about 2 to 20 mol %, preferably from about 5 to 15 mol %, based on the vinyl ester units present in the graft copolymers used.

The reaction preferably uses a solution of the graft copolymer P1) in which the solids content is in the range from 50 to 95% by weight, in particular from 60 to 85% by weight, and especially from 70 to 80% by weight.

Solids content and viscosity are advantageously selected so that the solution of the polymer P1) is easy to convey (to pump). They can be adjusted to the desired value via addition of water and/or C₁-C₆ alkanols.

According to the invention, the hydrolysis/alcoholysis of the graft copolymers having vinyl ester repeat units and having polyether groups takes place in the presence of at least one catalyst. It is possible to carry out this reaction in the presence of at least one acid as catalyst. However, acidic catalysts are generally used only when the graft copolymers have functional groups which are insufficiently resistant to bases. Examples of suitable acids are mineral acids, such as HCl, H₂SO₄, or H₃PO₄.

The catalyst used preferably comprises at least one base. This is preferably one selected among alkali metal hydroxides, such as NaOH and KOH, alkaline earth metal hydroxides, such as Ca(OH)₂, C₁-C₆-alkanolates of alkali metals and of alkaline earth metals, e.g. NaOCH₃, KOCH₃, Na(OCH₂CH₂), and Ca(OCH₂CH₂)₂, and mixtures of these. It is particularly preferable to use NaOH, KOH, or NaOCH₃, and NaOH is very particularly preferred.

The amount of the base used is usually in the range from 0.1 to 10 mol %, in particular from 0.2 to 5 mol %, and especially from 0.3 to 3.5 mol %, based on the vinyl ester units copolymerized in the graft copolymer P1). The degree of hydrolysis can also be increased within a wide range via use of higher amounts of base. However, even if very large excesses of base are used the hydrolysis achieved is generally not complete (100%), but is merely the maximum degree of hydrolysis possible as a function of the other reaction parameters (temperature, pressure, screw speed, etc.).

The form in which the base is used is preferably that of aqueous or alcoholic, particularly preferably alcoholic, solution. The solvent used for the base advantageously comprises the solvent previously used for the hydrolysis/alcoholysis of the polymer P1).

To terminate the reaction, the reaction mixture in the extruder may be treated with a neutralizing agent, i.e. with an acid in the case of base-catalyzed reaction, and vice versa. Suitable acids for neutralization are the mineral acids mentioned at the outset. Preference is given to carboxylic acids, in particular acetic acid. Suitable bases for neutralization are the bases mentioned at the outset as catalysts for the inventive process.

The types of extruder suitable for the inventive process are in principle the conventional types known to the person skilled in the art. These usually comprise a barrel, a drive unit, a plastifying unit composed of one or more rotating axles (screws) provided with conveying elements and/or with kneading elements, and also a control unit. Along the screw in the direction of conveying there are a number of zones, which in the inventive process comprise a feed zone, at least one reaction zone, and an output zone. In turn, each zone can comprise one or more barrel sections, these being the smallest independent unit.

Suitable extruders are single-screw extruders, twin-screw extruders, and multiple-screw extruders. In one preferred embodiment, a twin-screw extruder is used. Two or more screws may corotate or counterrotate, may be of intermeshing or tightly intermeshing design, and, if appropriate, may also have kneading disks and/or reverse-conveying elements.

In order to remove solvents, hydrolysis products, and/or water, the extruders used according to the invention preferably have at least one vent zone.

Downstream of the output zone, there may be at least one apparatus for further processing of the extrudates, e.g. an injection-molding machine, blow-molding system, or comminution system. For production of granules use may be made of a conventional pelletizer, for example.

The inventive process preferably uses twin-screw extruders, in particular Werner & Pfleiderer extruders of the ZSK series, e.g. the ZSK30. However, it is also possible to use other conventional extruders which similarly comply with the process requirements of the present invention. The person skilled in the art of reactive extrusion processes can use routine experiments to determine specific matching of the extruder design described here to other extruder models and extruder types.

Use of a twin-screw extruder with parallel screws is preferred.

To carry out the inventive process it is particularly advantageous to use an extruder which has been, at least to some extent, preferably completely, lined with a material which is inert under the reaction conditions, especially with a base-resistant material, such as fluorinated polyalkylenes, or whose surface is composed of appropriate qualities of steel.

One specific embodiment of the inventive process uses a twin-screw extruder having from 10 to 18, in particular from 12 to 15, and specifically 13 barrel sections, and an output die. By way of example, a ZSK30 twin-screw extruder with 13 barrel sections and output die is suitable for industrial realization of the embodiments below. However, the person skilled in the art of extrusion is aware of the existence of a wide variety of supplementary, modifying, or equivalent design possibilities for the extruder described for carrying out the inventive process, both in relation to a ZSK30 twin-screw extruder and also in relation to other conventional extruders. By way of example, the overall length of the extruder, or the length of individual zones, in particular the length of the reaction zone, can be varied by using a different or matched number of barrel sections.

The usual method of carrying out the inventive process feeds the aqueous or alcoholic solution of the graft copolymers P1) used in a first feed zone of the extruder, and feeds the aqueous and/or alcoholic solution of the base used in a second feed zone of the extruder. This introduction can, of course, also take place in a combined first feed zone. It is moreover possible to feed, to the extruder, a previously mixed solution which comprises the polymer P1) and comprises the base. The reaction of the ester groups with water or with the C₁-C₆ alkanol takes place in the downstream reaction zone of the extruder. The compounds eliminated from the graft copolymer P1) during this process are C₁-C₆ alkyl monocarboxylates during alcoholysis and monocarboxylic acids during hydrolysis. These cleavage products may generally be removed together with the solvent in the vent zone(s). This process can be promoted via introduction of water at a prior or intermediate stage, thus dissolving, to some extent or completely, the polymer phase or gel phase formed during the reaction. Downstream of the reaction zone of the extruder, i.e. at the extruder head or at the discharge orifice, the polymer product P2) can then be removed or conveyed into further tooling for further processing, e.g. for neutralization of the base used, and/or for shaping.

The extruder used in the inventive process advantageously has at least the following zones arranged in succession:
1st zone: feed zone for introduction of graft copolymers P1) used;
2nd zone: feed zone for the base;
3rd zone: reaction zone;
4th zone: mixing zone, if appropriate with water inlet;
5th zone: vent zone with one or more barrel sections for devolatilization at atmospheric pressure and/or in vacuo;
6th zone: output zone (e.g. in the form of an output die, output diaphragm, or other discharge orifice, preferably in the form of an output die).

There may also be one or more other zones, e.g. mixing zones, heating/cooling zones, vent zones, feed zones for neutralizing agents, and/or metering zones.

The 1st zone is the feed zone for the introduction of the graft copolymers P1) used, and generally comprises from 1 to 3, preferably from 2 to 3, barrel sections. This zone must be sealed between screw and barrel with respect to the drive apparatus in such a way that the starting materials cannot emerge backward from the machine.

In this 1 st zone, the screw used is preferably a single-flight screw, in order to provide an adequate pressure increase with respect to the hot reaction product. This characteristic can be supported by using conveying elements in this region of the screw.

The first barrel section in the direction of flow is generally a sealed barrel section. On the first or second, in particular the second, barrel section there is generally the feed apparatus for supplying the extruder with the graft copolymers P1) used. These are introduced by way of a metering pump, for example.

It has proven advantageous to keep all of the barrel sections of the first feed zone (1st zone), including that barrel section equipped with the feed apparatus, at ambient temperature or below. An example of a suitable temperature range is from 10 to 20° C., for example from 16 to 18° C. To this end, these barrel sections may be cooled slightly, e.g. using cold water. The barrel section downstream of the barrel section equipped with the feed apparatus for the polymer solution is advantageously heated to a temperature in the range from 50 to 70° C., in particular from 55 to 65° C., and especially about 60° C., an example of this barrel section being the third barrel section in the direction of flow, associated with the first feed zone (1st zone) or with the second feed zone for the base (2nd zone).

The 2nd zone is the feed zone for the base, and generally comprises one barrel section with a feed apparatus for supplying the extruder with an aqueous or alcoholic solution of the base. In this zone, the screw may have mixing elements, e.g. back-mixing elements, to provide good mixing of the components.

The solution of the base may be introduced using a pump, for example a piston metering pump. By way of example this introduction may take place under pressure, by way of an externally sealed feed neck. If appropriate, the solution of the base may be preheated prior to introduction, for example to a temperature in the range from 30 to 80° C.

The 3rd zone is the actual reaction zone, and generally comprises two or more, e.g. from 2 to 10, preferably from 3 to 8 and particularly preferably from 6 to 7, sealed barrel sections. In this region, the design of the screw is preferably such that conveying elements alternate with kneading blocks.

This 3rd zone is heated completely or to some extent, preferably completely, to a temperature of from 60 to 130° C., preferably from 70 to 110° C., particularly preferably from 80 to 100° C.

Between the 3rd and the 4th zone, a first vent zone with one or more, for example, 1 or 2, vent barrel sections may be integrated, if appropriate. A portion of the volatile constituents, such as solvents and/or cleavage products, can be removed at this early stage by way of one or more vents operated at atmospheric pressure or at subatmospheric pressure. The gas stream removed in this way may, for example, be condensed by way of a condenser associated with the extruder, and, if desired, introduced into further processing or work-up steps, such as separation of the components in distillation columns.

In the region of the vent zone, the screw advantageously has not only conveying elements but also kneading elements.

The 4th zone is a short mixing zone which, if appropriate, has a water inlet by way of which water can be introduced, using a piston metering pump. This zone is generally composed of one barrel section. In this region, the screw has conveying elements and, if appropriate, back-mixing elements.

The 5th zone is a vent zone with one or more, for example one or two, barrel sections for devolatilization at atmospheric pressure and/or in vacuo. It has proven advantageous to design the vent zone in such a way that it comprises a barrel section with vent necks for devolatilization at atmospheric pressure, followed by a sealed barrel section, and comprises a barrel section having vent necks for devolatilization in vacuo.

The design of the screw here is advantageously such that it has conveying elements in the region of the barrel sections equipped with the vent necks, and, between these, in particular in the region of the sealed barrel section, has kneading blocks.

The volatile constituents still present, such as solvents, cleavage products, and also, if appropriate, added water with contaminants present therein can substantially be removed in this vent zone. The gas stream removed in this way may, for example, be condensed by way of a condenser associated with the extruder, and, if desired, introduced into further processing or work-up steps, such as separation of the components in distillation columns.

The temperatures in the mixing zone (4th zone) and/or vent zone (5th zone) are advantageously set to 130° C. or below, preferably 110° C. or below, particularly preferably 100° C. or below, and very particularly preferably about 90° C. The temperature selected here is usually the same as that set in the reaction zone.

Downstream of the vent zone toward the distal end of the extruder is the output zone (6th zone). In one suitable embodiment, this comprises a metering zone (homogenizing zone) prior to the actual output apparatus. In this metering zone, the homogenizing action of the screws can be reinforced via appropriately formed mixing elements. In addition, mechanical conveying can be interrupted in order to bring about forced and more intensive interchange of material. The actual output apparatus is in essence composed of the extruder head or of the attached output die, output diaphragm, or other discharge orifice, e.g. a round-section die, slot die, or perforated diaphragm. The temperature in the output zone (inclusive of any metering zone present and of the discharge orifice) is preferably above 150° C., particularly preferably above 155° C., and in particular about 160° C.

Compliance with the temperature profile described in the various extruder zones is important because, inter alia, it affects the rate of conversion of the vinyl esters to vinyl alcohol. It has been found that selecting a higher reaction temperature generally gives a lower rate of conversion. A higher reaction temperature can moreover cause, mostly undesirable, dark coloration of the reaction product, and it is therefore advantageous to limit the temperature to the maximum values described above. It has also proven advantageous for the temperature selected in the output zone not to be too low, because otherwise the extruder head tends to become blocked.

To carry out the inventive process, the screws of the extruder are preferably operated at a rotation rate in the range from 100 to 1500 rpm, preferably from 250 to 1000 rpm. Higher degrees of hydrolysis can generally be achieved via higher rotation rates.

The residence time of the reaction mixture in the extruder is preferably less than 30 min, particularly preferably less than 10 min, and is in particular in the range from 0.5 to 5 min, and especially from about 1 to 2 min. The residence time depends, inter alia, on the level of fill used when operating the extruder. Longer residence time in the extruder generally achieves an increased degree of hydrolysis.

The inventive process generally permits achievement of a degree of hydrolysis in the range from 80 to 98%, preferably from 84 to 94 mol %, based on the vinyl ester units copolymerized in the graft copolymer used.

To the extent that neutralization has not taken place by this stage in the extruder, the resultant graft copolymers P2) can be neutralized prior to any subsequent further processing. For this, by way of example, the graft copolymers may be transferred to a suitable container which permits temperature control, e.g. to a tank, reactor, or vessel equipped with stirrer and with cooling apparatus, for neutralization of the basic or acidic catalyst. The neutralization advantageously takes place in an organic solvent in which the resultant block copolymer is insoluble or has only very low solubility, thus easing subsequent isolation of the graft copolymers from the liquid phase, e.g. via filtration. Examples of suitable solvents here are alcohols, such as methanol, esters of organic carboxylic acids, e.g. methyl acetate and ethyl acetate, and mixtures of these. If appropriate, the organic solvents may be used in combination with a very small amount of water, e.g. 2% by weight, based on the total weight of the solvent mixture. During the neutralization step, the temperature of the solvent mixture used is usually such that the resultant graft copolymers solidify during the process. The block copolymers obtained at the extruder head are preferably passed without any neutralization step to a further process or to a subsequent use.

The block copolymers obtained at the extruder head or at the discharge orifice and comprising vinyl alcohol in copolymerized form are generally obtained in the form of a continuous extrudate with preferably constant cross section, e.g. in the form of a strip or strand, in particular with round, oval, rounded, or flat and wide cross section, and can be removed and, prior to or after solidification, further processed. Prior to complete solidification, at least one molding step preferably takes place downstream of the discharge orifice of the extruder. After solidification, the resultant block copolymers can, if appropriate, be put into intermediate storage and passed to further processing, in particular to further shaping, in a wide variety of tooling, in particular to injection molding or to foil extrusion. As an alternative for the same purpose, they may also be passed, e.g. directly extruded, into this tooling prior to complete solidification.

Examples of methods for the molding process prior to solidification are, depending on the viscosity of the resultant block copolymer extrudate, casting, injection molding, film extrusion, compression molding, pinching, or calendering. By way of example, therefore, the block copolymers obtained by the inventive process may be obtained in granular form, for example, or directly in the form of a foil. The inventive process is preferably used to produce granules of the extruded block copolymers.

Particularly suited for extrudate-molding steps downstream of the extruder discharge orifice, which itself has shaping action, are the cold-cut process, the hot-cut process, and pinch-off of the at least not completely solidified strand in a pinching device, these being conventional processes known to the person skilled in the art. The cold-cut process means the cutting or chopping of the strand after at least partial solidlficiation, while the hot-cut process means the cutting or chopping of the strand prior to its solidification. The hot- or cold-cut process can in particular produce granules (hot-cut or cold-cut granulation) and pellets.

The graft copolymers P2) obtained via the inventive process, in particular the granules thereof, are particularly advantageously suitable for use as starting material in injection-molding or foil-extrusion processes, very particularly for production of water-soluble coatings and of packaging materials, such as foils. A particular feature of the granules of block copolymers prepared by the inventive process is their capability for simple and uniform introduction into the respective tooling used, e.g. a conventional injection-molding machine or foil-extrusion system.

The inventive process is particularly suitable for continuous operation.

The example below illustrates the invention, but there is no intention to restrict the subject-matter of the invention in any respect.

### EXAMPLES

I. Extruder Design

A ZSK30 twin-screw extruder from Werner & Pfleiderer, Stuttgart, Germany was used, with 13 barrel sections, and an output die. This extruder had the following zones:

| | |
|---|---|
| 1st zone | Feed zone with feed necks for solution of the graft |
| | copolymers used |
| 2nd zone | Feed zone with feed necks for the base |
| 3rd zone | Reaction zone |
| | (1st) Vent zone with vent necks for devolatilization |
| | at atmospheric pressure |
| 4th zone | Mixing zone with water inlet |
| 5th zone | (2nd) Vent zone with vent necks for two-stage devolatilization |
| | at atmospheric pressure and in vacuo |
| 6th zone | Metering zone and output die |

II. Preparation of Polyethylene Glycol-Polyvinyl Acetate Graft Copolymer

A polyethylene glycol-polyvinyl acetate graft copolymer (PEG-g-PVAc copolymer) was prepared as described in example 1 of WO 00/18375, via graft copolymerization of 410 g of vinyl acetate onto 72 g of polyethylene glycol (number-average molecular weight 6000, Pluriol® E 6000, BASF Aktiengesellschaft). The ratio of polyethylene glycol to vinyl acetate was 15:85. A polymer solution was prepared via dilution with methanol and had viscosity of 36 200 mPas, with solids content of 76.6% by weight.

III. Methanolysis of PEG-g-PVAc Copolymer

The methanolic polymer solution prepared as described in II. was introduced into the extruder described in I. by way of the feed neck of the first feed zone at ambient temperature with the aid of a metering pump. A methanolic NaOH solution was continuously metered in by way of the second feed zone in such a way as to achieve a starting amount of 1.8 mol %, based on the vinyl acetate groups present in the graft copolymer used. The second feed zone (2nd zone) composed of the barrel section provided with feed necks for the base was temperature-controlled to 60° C. Barrel sections 4-13 (3rd to 5th zone) were heated to a temperature of 90° C., and the output zone was heated to a temperature of 160° C. The rotation rate of the screws was 550 rpm.

This gave a PEG-g-PVA copolymer with a degree of hydrolysis of 88.9%, a number-average molecular weight Mn of 9300, a weight-average molecular weight Mw of 21 900, and polydispersity Mw/Mn of 2.4.

1. A process for preparing of graft copolymers P2 that have repeat units derived from vinyl alcohol and have polyether groups, the process comprising contacting graft copolymers precursors that have repeat units derived from esters of vinyl alcohol and have polyether groups with water or with at least one C₁-C₆ alkanol or a mixture of the water and the alkanol in the presence of a catalyst, where the reaction with the precursors and the water, the alkanol or mixture thereof occurs in an extruder.

2. The process according to claim 1, where the graft copolymer precursor is obtained by polymerization of at least one ester of vinyl alcohol with a monocarboxylic acid and, optionally with at least one other α,β-ethylenically unsaturated monomer, in the presence of at least one polyether.

3. The process according to claim 2, wherein the precursors have a ratio by weight of the polyether groups with respect to the repeat units derived from esters of vinyl alcohol in the range from 1:0.5 to 1:50.

4. The process according to claim 1, wherein the graft copolymer precursor includes at least one polyethylene glycol-polyvinyl acetate graft copolymer.

5. The process according to claim 1, wherein the at least one C₁-C₆ alkanol in an excess of from 2 to 20 mol %, based on the vinyl ester units present in the graft copolymers precursors.

6. The process according to claim 1, wherein contacting the graft copolymer precursors with the water, the alkanol or the mixture thereof forms a reaction mixture with a solids content from 50 to 95% by weight.

7. The process according to claim 1, where the extruder has the following zones arranged in succession:
1st zone: feed zone for introduction of graft copolymers precursors;
2nd zone: feed zone for a base;
3rd zone: reaction zone;
4th zone: mixing zone;
5th zone: vent zone; and
6th zone: output zone.

8. The process according to claim 7, where the output zone has a temperature of more than 150° C. and the reaction zone has a temperature of 130° C. or less.

9. The process according to claim 1, wherein the extruder comprises a twin-screw with parallel screws.

10. The process according to claim 9, where the extruder is operated with a rotation rate of the screws from 100 to 1500 rpm.

11. The process according to claim 1, wherein at least a portion of the extruder is lined with a material which is inert under the reaction conditions.

12. The process according to claim 1, which achieves a degree of hydrolysis from 80 to 98%, based on the vinyl ester units copolymerized in the graft copolymer precursors.

13. The process according to claim 1, where the graft copolymers P2 are further processed to provide granules or a foil.

14. The process according to claim 3, wherein the ratio by weight is from 1:1.5 to 1:30.

15. The process according to claim 6, wherein the solids content of the reaction mixture is from 60 to 85% by weight.

16. The process according to claim 7, wherein the extruder comprises a twin-screw with parallel screws.

17. The process according to claim 2, wherein the polyether comprises at least one polyalkylene glycol with a number average molecular weight of from 500 to 10,000.

18. A process comprising:
inputting a mixture comprising graft copolymer precursors, and water, C₁-C₆ alkanol or a mixture thereof to a first feed zone of an extruder;
inputting a base to the first feed zone or a second feed zone downstream from the first feed zone of the extruder; wherein the reaction between the graft copolymer precursors and the water, the C₁-C₆ alkanol or the mixture thereof occurs primarily in a reaction zone of the extruder; and
removing the graft copolymer product from the output zone of the extruder.

19. The process of claim 18 further comprising removing the hydrolysis product generated primarily in the reaction zone in a vent zone positioned between the reaction zone and the output zone of the extruder.

20. The process of claim 18 further comprising subjecting the graft polymer product to a tooling device selected from the group consisting of an injection molding device, a foil forming device and a cold-cut pinching device.

21. The process of claim 18 wherein the reaction zone is maintained at a temperature from 70° C. to 110° C.

22. The process of claim 21 wherein the output zone is maintained at a temperature above 150° C.

23. The process according to claim 18, wherein the graft copolymer precursor and the water, the C₁-C₆ alkanol or the mixture thereof in the reaction zone provides a reaction mixture in the reaction zone with a solids content of from 60 to 95% by weight.

24. The process according to claim 18, wherein the graft copolymer precursor includes at least one polyethylene glycol-polyvinyl acetate graft copolymer.
